(19) United States
(12) Patent Application Publication
(10) Pub. No.: US 2008/0060932 A1
(43) Pub. Date: Mar. 13, 2008

(54) PUMPING LINE DEVICE OF DRY ETCHING APPARATUS

(76) Inventor: Jae-Soung Kim, Seoul (KR)

Correspondence Address: SHERR & NOURSE, PLLC, 620 HERNDON PARKWAY, SUITE 200, HERNDON, VA, 20170, US

(21) Appl. No.: 11/847,016

(22) Filed: Aug. 29, 2007

(30) Foreign Application Priority Data
Sep. 12, 2006 (KR) 10-2006-0087737

(51) Int. Cl. H05F 3/00; B01J 19/12

(52) U.S. Cl. 204/164; 422/186.05

(57) ABSTRACT

Disclosed herein is a pumping line for a plasma dry etching device. The pumping line discharges charged ions or reactive byproducts generated after the etching process and includes a high frequency applying coil which circumferentially surrounds an outer wall of the pumping line, a high frequency generator connected to the high frequency applying coil, and a gas injecting port which injects a plasma reaction gas through one end of the pumping line to produce a plasma in the pumping line.

The present application claims priority under 35 U.S.C. 119 to Korean Patent Application No. 10-2006-87737 (filed on Sep. 12, 2006), which is hereby incorporated by reference in its entirety.

### BACKGROUND

During the manufacture of semiconductor integrated circuits (IC), an etching devised is utilized to form a fine structure having a desired shape by selectively removing only a portion of a wafer or a thin film deposited on the wafer. By repeatedly conducting a thin film forming process and an etching process, a semiconductor device having a complicated structure is manufactured. The etching process may be used to remove a desired material from the surface of a wafer, and particularly, to selectively remove a portion which is not covered with a photoresist. Thereafter a photoresist pattern may be formed using a photolithographic process as a mask. Etching can occur in a wet etching environment or a dry etching environment. Wet etching has limitations, one of which is a result of its isotropic nature. The isotropic nature of wet etchants are problematic when the minimum pattern dimension of a substrate is comparable to the thickness of the etching material. This results in difficulties in obtaining precise dimensions on a substrate. Consequently, since the latter half of 1970s, the dry etching process using plasma has been preferred.

Dry etching may be performed using a variety of methods such as a reaction ion etching method, most of which uses plasma. In a plasma etching process, defects may occur in the resultant semiconductor device due to the production of particles. Such particles may diminish the overall yield during the etching process. The particles may have a variety of shapes and may cause problems such a flake phenomenon or contamination of a loadlock chamber due to difficulties that occur within the chamber or transport system during the deposition process.

Chamber contamination can be solved by preventive maintenance in a relatively short time. However, the pumping line may accumulate byproducts while maintaining a lengthy vacuum state. Thus, the pumping capability of the pumping line may deteriorate and may also flow backward in the chamber, and thereby becoming the source of particles. The pumping line may be difficult to clean using preventive maintenance due to the mechanical structure of a dry etching apparatus. Moreover the overall time to clean the pumping line lengthy, and thus, the operation rate of the apparatus and device manufacturing yield are reduced.

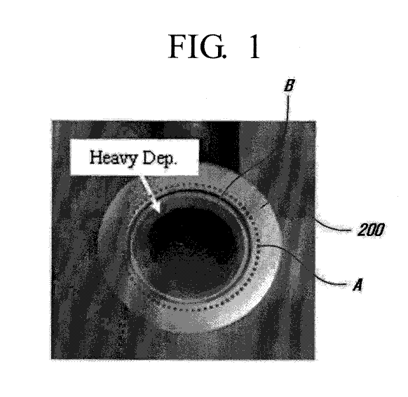

The pumping line includes a turbo pump for maintaining a high pressure state and a dry pump for maintaining a low pressure. The turbo pump and the dry pump are utilized to maintain pressure in the process chamber of the dry etching apparatus. Charged ions or polymer-based byproducts, which are generated after plasma etching, are discharged through the pumping line. The charged ions or polymer-based byproducts are gradually accumulated on the inner wall of the pumping line. Example FIG. 1 illustrates pumping line 200 whereby film B having a large thickness (see a region A) has accumulated on an inner wall thereof. Film B had accumulated over a long period of time, and an attempt to eliminate film B was conducted by attaching a heating unit to pumping line 200. This solution, however, is not practical.

### SUMMARY

In accordance with embodiments, a pumping line of a dry etching apparatus is provided that is capable of suppressing or otherwise eliminating undesirable film accumulation.

In accordance with embodiments, a pumping line device of a dry etching apparatus is provided including a plasma generation device such as a high frequency coil surrounding an outer wall of the pumping line; a high frequency generator connected to the high frequency coil; and a gas injecting port for injecting a plasma reaction gas through one end of the pumping line.

### DRAWINGS

Example FIG. 1 illustrates film accumulation in a pumping line of a dry etching apparatus.

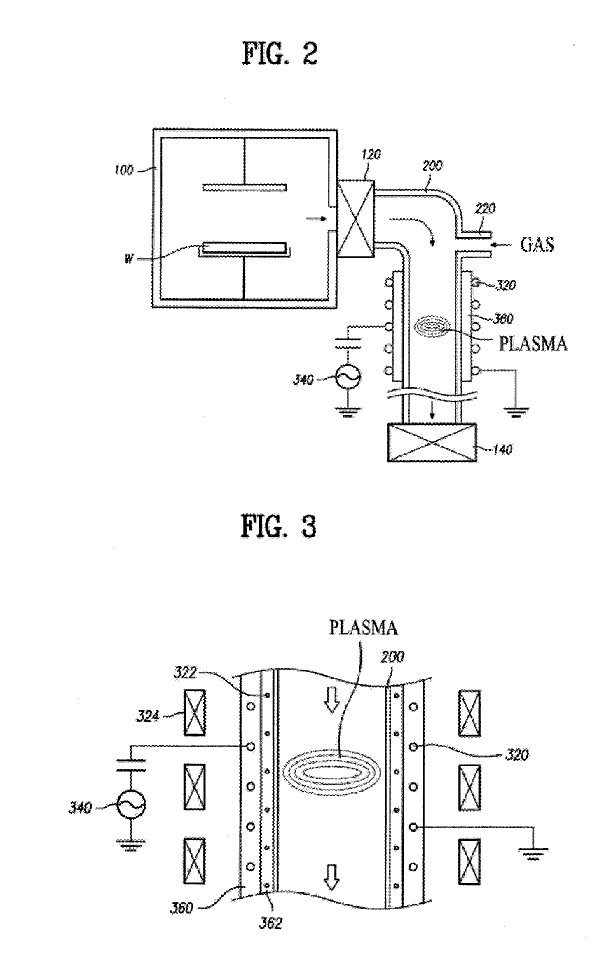

Example FIGS. 2 and 3 illustrate a pumping line device in accordance with embodiments.

### DESCRIPTION

Illustrated in example FIG. 2 is a dry etching apparatus having wafer W positioned on a substrate holder in plasma etching chamber 100 to undergo etching. Pumping line 200 in accordance with embodiments is utilized for discharging charged ions or byproducts generated after etching. One end of pumping line 200 is connected to turbo pump 120 provided at etching chamber 100 while another end of pumping line 200 is connected to dry pump 140. Turbo pump 120 maintains a high pressure state of etching chamber 100. The charged ions or byproducts generated after etching in etching chamber 100 are discharged to pumping line 200 through turbo pump 120. The discharged charged ions or the polymer-based byproducts are discharged through dry pump 140 by pumping line 200.

High frequency applying coil 320 and high frequency generator 340 are provided on an outer wall of pumping line 200. High frequency applying coil 320 is provided to circumferentially surround the outer wall of pumping line 200. A high frequency generated at high frequency generator 340 and is transferred to the inside of pumping line 200 through high frequency applying coil 320. This high frequency helps generate plasma within pumping line 200. A plasma reaction gas is introduced or otherwise injected into pumping line 200 by gas injection port 220. The plasma reactive gas introduced into pumping line 200 has a cleaning function for removing undesirable film from etching chamber 100. Gas injection port 220 may be fluidically connected to pumping line 200 at an area between the fluid connection points of pumping line 200 and turbo pump 120 and pumping line 200 and dry pump 140. The plasma reaction gas may come from at least one of O₂, CF₄ and NF₃. The amount of the injected plasma reaction gas may be determined in accordance with the capacity of dry pump 140.

Plasma may be generated in pumping line through application of a high frequency by high frequency generator 340 and either the gas discharged from etching chamber 100 and introduced into pumping line 200, or the gas injected through gas injection port 220 and introduced into pumping line 220. The accumulated film on the inner wall of pumping line 200 reacts with reaction gas by the generated plasma and is removed or otherwise discharged along pumping line 200 toward dry pump 140 provided at the side opposite to the etching chamber 100.

In accordance with embodiments, pumping line 200 can operate even during the etching process. In such case, since the charged ions or the byproducts are introduced into pumping line 200 and reaction is suppressed by the plasma generated in pumping line 200, the charged ions or the byproducts cannot accumulate on the inner wall of pumping line 200 and instead are discharged through dry pump 140. High frequency power applied to pumping line 200 may be as low as between approximately 10 to 100 W.

In accordance with embodiments, when an etching process is not being conducted, the pumping line can operate to perform preventive maintenance. In this case, in order to remove accumulated film from pumping line 200, high frequency power (i.e. 100 W or less) may be applied for a predetermined time to remove the accumulated film.

As illustrated in example FIG. 3, in order to more efficiently remove the accumulated film from pumping line 200, heating coil 322 may be provided on a sidewall of pumping line 200. Heating coil 322 may be provided in a fire resistance layer 362. If pumping line 200 is composed of a metal pipe, in order to prevent interference with high frequency applying coil 320, a predetermined insulating film such as a silicon film may be provided between high frequency applying coil 320 and pumping line 200. In order to more easily generate plasma in pumping line 200, magnetic field generation coil 324 may be provided outside pumping line 200. Magnetic field generation coil 324 may be provided to surround the outer wall of pumping line 200 such that a magnetic field and a high frequency are combined to generate plasma having high density.

Accordingly, it is possible to remove undesirable particles generated due to film accumulation in a pumping line, such film formation reducing pumping efficiency. In accordance with embodiments, the pumping line device may easily remove the accumulated film without need to service the device by removing the pumping line, which can often be a difficult task. Thus, the operation rate of an etching process is increased as well as the manufacturing yield.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
a pumping line in fluidic connection with an etching chamber;
a high frequency coil surrounding an outer wall of the pumping line for generating plasma in the pumping line;
a high frequency generator connected to the high frequency applying coil; and
a gas injecting port for injecting a plasma reaction gas through the pumping line.

2. The apparatus of claim 1, wherein one end of the pumping line is connected to a turbo pump provided between an etching chamber of the dry etching apparatus and the pumping line, and the other end of the pumping line is connected to a dry pump.

3. The apparatus of claim 2, wherein the gas injecting port is provided along a flow line of the pumping line adjacent to the connection point between the pumping line and the turbo pump.

4. The apparatus of claim 1, further comprising an insulating film interposed between the high frequency applying coil and an outer wall of the pumping line.

5. The apparatus of claim 1, further comprising a heating unit for heating the pumping line.

6. The apparatus of claim 1, further comprising a magnetic field generation coil which circumferentially surrounds the outer wall of the pumping line to generate a magnetic field in the pumping line.

7. The apparatus of claim 1, wherein the plasma reaction gas is at least one of O₂, CF₄ and NF₃.

8. An apparatus comprising:
a pumping line in fluidic connection with an etching chamber;
a power source for generating a high frequency;
a high frequency coil connected to the high frequency power source for receiving the high frequency from the power source and transferring the high frequency to the pumping line to produce plasma within an annular space in the pumping line;
a gas injecting port fluidically connected to the pumping line for introducing a plasma reaction gas through the pumping line, wherein the plasma reactive gas combines with the high frequency introduced by high frequency coil to produce plasma inside the annular space of the pumping line;
a heating coil which circumferentially surrounds the pumping line; and
a magnetic field generation coil for producing a magnetic field in the pumping line, wherein the magnetic field, plasma reaction gas and high frequency combine to generate a high density plasma within the pumping line.

9. The apparatus of claim 8, wherein the high frequency coil circumferentially surrounds the pumping line.

10. The apparatus of claim 8, wherein the amount of plasma reaction gas introduced by the gas injecting port is determined in accordance with the capacity of a dry pump fluidically connected to an end of the pumping line.

11. The apparatus of claim 8, wherein the high frequency power source comprises a generator.

12. The apparatus of claim 11, wherein the high frequency produced by the generator is between approximately 10 to 100 W.

13. The apparatus of claim 8, wherein the pumping line can operate during an etching process within the etching chamber.

14. The apparatus of claim 8, wherein the heating coil is provided on a fire resistance layer which circumferentially surrounds the pumping line.

15. The apparatus of claim 8, wherein an insulating film is interposed between the high frequency coil and the pumping line to prevent interference with the high frequency applying coil.

16. The apparatus of claim 15, wherein the insulating film comprises silicon.

17. A method comprising:
fluidically connecting a pumping line to an etching chamber;
applying a high frequency to the pumping line;
applying heat to the pumping line;
applying a magnetic field to the pumping line;
injecting a plasma reaction gas in the pumping line, wherein the plasma reaction gas combines with the high frequency, the heat and the magnetic field to produce high density plasma in the pumping line.

18. The method of claim 17, wherein the high frequency is applied using a generator.

19. The method of claim 18, wherein the high frequency produced by the generator is between approximately 10 to 100 W.

20. The method of claim 17, wherein the plasma reaction gas is at least one of O₂, CF₄ and NF₃.
